(19) United States
(12) Patent Application Publication
(10) Pub. No.: US 2006/0190396 A1
(43) Pub. Date: Aug. 24, 2006

(54) REAL ESTATE SALES/FINANCING PLAN

(76) Inventor: EDWARD W. WINTERHALDER, Owasso, OK (US)

Correspondence Address: HEAD, JOHNSON & KACHIGIAN, 228 W 17TH PLACE, TULSA, OK, 74119, US

(21) Appl. No.: 10/906,529

(22) Filed: Feb. 23, 2005

(51) Int. Cl. G06Q 40/00

(52) U.S. Cl. 705/39

(57) ABSTRACT

A business method provides for the sale of real estate to persons ineligible for credit from typical financial institutions. A real estate financial entity purchases real estate and sells it to a buyer via a sales contract comprising scheduled monthly payments wherein title is transferred upon completion of all scheduled payments. The new purchase is secured by the property and allows sale to high-risk buyers.

### BACKGROUND

The present invention relates to a method for buying, selling and financing real estate. Specifically, the present invention allows access to home ownership for persons typically incapable of purchasing a home through conventional means. The unique business method and structure provides a cost effective means providing housing and land ownership to persons otherwise unable to obtain it.

U.S. Pat. No. 5,664,115 issued to Fraser on Sep. 2, 1997 discloses a method and apparatus of automatically matching sellers of property with potential buyers through a communications network in which a host system communicates with the sellers and the potential buyers over telephone or dedicated data transmission lines. The host system obtains and stores records corresponding to a property. The records can then be searched by a remote data terminal associated with a buyer. The results are then provided to the buyer, who indicates specific property listings that he may be interested in purchasing. The buyer provides identifying information which is then provided to the sellers. The system permits automatic evaluation of buyers to screen buyers whose information does not match minimum criteria provided by the seller. U.S. Pat. No. 5,857,174 issued to Dugan on Jan. 5, 1999 discloses a real estate appraisal method in which the buyer of a property assigns points to a subject property and comparable property based upon an Ideal Point System (IPS). The points assigned, or IPS values, are based upon the desirability factors of five categories of criteria. Once the buyer's IPS values are determined, the property may be subsequently used as a comparable property. The appraiser need only select a subject property and obtain IPS values for the subject property. The sales price of each comparable property is then adjusted based upon the relative difference between the IPS values for the comparable properties and the IPS values of the subject property, by dividing the total IPS value for each comparable property with the IPS value for the subject property to obtain a composite adjustment ratio.

U.S. Pat. No. 6,292,788 issued to Roberts et al. on Sep. 18, 2001 discloses methods and investment instruments for investing in real estate wherein a portfolio of investment real estate is divided into a plurality of tenant-in-common deeds, and which are subject to a master agreement and master lease to form “deedshares.” Holders of the deedshares receive a guaranteed income stream from the master lease and yearly depreciation, without having to maintain or manage the real estate.

U.S. Pat. No. 6,321,202 issued to Raveis, Jr. on Nov. 20, 2001 discloses a system for managing real estate transactions. The method includes the steps of receiving and storing data relating to a plurality of contacts including buyers and sellers of real estate, receiving and storing data relating to a plurality of vendors each associated with at least one phase of a real estate transaction, accessing vendor data based upon occurrence of a particular phase of the real estate transaction and communicating data relating to the vendors to a contact upon occurrence of the particular phase of the real estate transaction.

U.S. Pat. No. 6,356,878 issued to Walker et al. on Mar. 12, 2002 discloses a conditional purchase offer (CPO) buyer agency system for processing variable conditional purchase offers (CPOs) containing at least one variable condition. If a posted CPO is not accepted by at least one seller for a predefined period of time, or has been rejected by all potential sellers, the terms of the posted CPO may be modified to facilitate acceptance. A buyer can submit a variable CPO having two sets of conditions, as well as corresponding buyer-defined offer price for each condition set. U.S. Pat. No. 6,401,070 issued to McManus et al. on Jun. 4, 2002 discloses a method and system for estimating real estate property values based on repeat sales model. The method estimates the price index using property value data from refinance transactions, as well as from purchase transactions. In so estimating, the method compensates for the transaction bias arising from using data from refinance transactions, which may exhibit incentive and selection biases.

U.S. Pat. No. 6,484,153 issued to Walker et al. on Nov. 19, 2002 discloses a central controller that receives an offer signal. The central controller also receives a payment identifier signal for specifying an account from which funds may be paid. An informational signal relevant to the offer is received from a third party. The central controller transmits the offer signal and the informational signal to at least one seller. In response, an acceptance signal is received from at least one of the sellers.

U.S. Pat. No. 6,539,401 issued to Fino et al. on Mar. 25, 2003 discloses a system for facilitating the information transfer and processing associated with home construction and home sales. Various discrete software modules are disclosed each handling a specific task associated with home construction and sales.

U.S. Pat. No. 6,553,347 issued to Tavor et al. on Apr. 22, 2003 discloses a method for conducting “one to one” commercial negotiations through an electronic medium such as the Internet. The negotiation process consists of sending persuasive texts to the user by the system, including discounts given by the system and responses to the price offers of the user. The system offers the product for a specific price, a price that may be optionally decreased as negotiation continues. The system frequently asks how much the user is willing to pay for the product. Based on the user's input, the system may accept the offer or, after one or more unacceptably low inputs from the user, may alternatively end the process of negotiation. U.S. Pat. No. 6,564,190 issued to Dubner on May 13, 2003 discloses a rule-based decision process which formulates an investment strategy in terms of short term debt, long term debt, short term equity, and/or long term equity for a variety of property types and geographic markets. The first phase of the method achieves a visual representation of the condition of each of a selected territory's major markets, showing market direction and volatility determined on the basis of commercially available market research data which has been adjusted by the investing entity in light of actual local experience in the market. The second phase deals with the implications of the first phase results on four possible alternative investment types, namely, short term debt, long term debt, short term equity, and/or long term equity. This is accomplished by formulating a set of decision rules which enable the individual investors of the investing entity to uniformly evaluate specific types of investment for each property type in a respective market area.

U.S. Pat. No. 6,594,633 issued to Broerman on Jul. 15, 2003 discloses a real estate computer network that facilitates a real estate transaction between a buyer and a seller by electronically communicating between the parties and third parties such as real estate facilitating entities (e.g., lawyer, mortgage provider, title provider) over a network. Each stage of the transaction is supported by the parties utilizing an online real time interactive communication interface to list property information; to search for a property in a property database; to negotiate via an electronic purchase contract; and to schedule associated events and deadlines.

U.S. Pat. No. 6,615,187 issued to Ashenmil et al. on Sep. 2, 2003 discloses a method of creating, purchasing and selling the real estate brokerage commissions typically collected upon the sale of real property. A property owner sells, for a certain consideration, the assignable option to be the owner's broker when the owner decides to resell the property. The compensation paid may be in the form of cash or an equivalent incentive. U.S. Pat. No. 6,684,196 issued to Mini et al. on Jan. 27, 2004 discloses methods and apparatus for facilitating a transaction corresponding to real property between a seller and a buyer via a network. A negotiation relating to the real property between the buyer and the seller is facilitated via the network. Access by at least one of the buyer and the seller via the network to a plurality of real estate services is provided.

U.S. Pat. No. 6,704,716 issued to Force on Mar. 9, 2004 discloses a method and system for conducting an online transaction that allows a seller and a bidder to negotiate a final sale price. The system displays information about the item. An offer is received from at least one bidder. The system enables the seller and bidder to negotiate by allowing each party a predetermined number of responses. After the predetermined number of responses is met without a sale, the system enables the seller and a subsequent bidder to negotiate.

U.S. Pat. No. 6,751,596 issued to Hastings on Jun. 15, 2004 discloses a system and method for tracking, monitoring, and supporting self-procurement of real estate. An individual would be entitled to the real estate commission payable to licensed real estate agents. To aid the buyer in his self-procurement activities, the system provides information to the buyer of property listings that match the search criteria. The system also provides comparable sales information of other homes in the area, school district reports, environmental hazard reports, and automated offer drafting assistance. If the buyer wants to view a property, the system coordinates such viewing by contacting chaperones to provide the showing of the property. U.S. Pat. No. 6,766,322 issued to Bell on Jul. 20, 2004 discloses a process for the full disclosure of potential detrimental conditions affecting property transactions organizes the spectrum of disclosure issues that are important to lenders and prospective buyers. The real estate disclosure reporting method includes the compilation of a comprehensive list of items of disclosure based upon federal, state, lender and market requirements. These items of disclosure are classified according to condition categories that provide a systematic procedure for researching and a logical organization for reporting known conditions. A disclosure form provides a listing of the items of disclosure according to these categories.

U.S. Pat. No. 6,823,319 issued to Lynch et al. on Nov. 23, 2004 discloses automated deal processing for customers, and includes prompting a customer for at least one deal parameter, such as loan amount, prompting the customer for information relating to the customer, such as collateral offered by the customer, accessing in real-time information relating to the credit history of the customer, applying a plurality of origination rules, such as exclusionary rules, pricing rules, risk rules, and edit preference rules, to the at least one deal parameter and the information relating to the customer, applying at least one strategy, such as compensation for risk, repair, or upsell, to the results of the application of the rules, generating at least one deal based on the accessing and applying of the strategy, and presenting the customer with the at least one option.

U.S. Pat. No. 6,826,552 issued to Grosser et al. on Nov. 30, 2004 discloses a computer-aided decision-making system and method that is applicable to a variety of decision-making contexts and applications such as automobile or home purchase decisions. The computer-aided decision-making system provides information to a person in a decision-making context, overcoming common human cognitive problems that occur in decision-making, and enabling consumer purchases in an on-line sales environment.

Buying a new home is typically a very complex process. Both the buyer and the seller must obtain an agent to help them locate a suitable house and a suitable buyer. A contract for sale is then negotiated. Various inspections and other processes must also take place. Credit must be secured from a financial institution. These financial institutions are hindered by required compliance with federal guidelines in the loan of money for the purchase of a home. All of these factors serve to complicate the home purchasing process. In addition, substantial down payments are required, as well as mortgage insurance. The real estate agents must also be compensated. These factors lead to a substantial increase of cost to the purchaser.

All of the above factors contribute to the difficulty in purchasing a home. The actual cost of the purchase is in far excess of the actual cost of the real estate. The federal regulations that financial institutions are required to follow prevent them from offering credit to many persons. Persons having a poor credit history, a relatively low income, who lack a driver's license or social security number, who are self employed, who are senior citizens, are all ineligible for such loans. In addition, people of meager means find it even more difficult to pay the overhead costs included with the purchase of a home. This leaves a substantial portion of the population unable to achieve home ownership. Home ownership is highly advantageous in our society. It provides security for a family and allows a person to accumulate wealth in a real estate investment, rather than paying a monthly rent.

It is therefore desirable to provide a simpler, more affordable method of purchasing real estate.

It is also desirable to provide a means for persons of modest wealth who do not own real estate.

### SUMMARY OF THE INVENTION

The present invention provides a cost effective and even lucrative method of providing home ownership to persons typically unable to afford such. In the present invention, one or more homes, usually new or like new, are purchased through typical real estate transaction methods. The purchaser, in many senses, acts as a “straw man.” Once the homes have been purchased, the buyer then acts as both a seller and lender by selling the property utilizing an “owner carry” or “owner financed” or “owner financing” financing program that does not require the buyer to qualify for that loan.

The Real Estate Financial Entity (REFE) is an individual or corporation or partnership or other business entity, preferably having at least one investor having a sufficient credit history and meeting other guidelines such that a financial institution may extend credit in the form of a mortgage to the REFE at a reasonable interest rate. The REFE then sells real estate to a buyer at a reasonable amount. The purchase is made through scheduled payments over a 15 year, 20 year, 30 year or other amount of years payment plan. Upon completion of the final payment, title is transferred from the REFE to the buyer. Because the REFE maintains ownership of title to the real estate until the final purchase payment is made, the REFE undertakes very little risk in the sale. Because of this, the REFE is able to sell homes to practically any person without the need to perform a credit check or verify practically any information at all about the buyer. This allows persons in or just out of bankruptcy, persons with bad credit, persons that are self employed, persons that are legal immigrants, persons that are senior citizens, or persons who have difficulty verifying their history or background to easily purchase real estate. The present invention of a business method for an REFE is especially beneficial when used in conjunction with typical real estate developers. New real estate developments sell off individual lots and/or homes as quickly as possible. Once substantially all of the lots and/or homes have been sold, the developer is especially anxious to sell the remaining lots and/or homes and move on. Typically these remaining lots and/or homes will be sold at a reduced price. Furthermore, if the remaining lots and/or homes are all sold together, the developer will typically further reduce the cost of each lot and/or homes. The present invention includes purchasing remaining lots and/or homes of a development in bulk at a reduced rate. The REFE has no need to sell these lots and/or homes as quickly as possible and may therefore demand a better price than the developer was going to wait for. The REFE may then sell these lots and/or homes to persons otherwise unable to purchase homes by means of the above-described purchase contracts. The system allows the REFE to grow into a rather large company, become incorporated and eventually selling its' stock.

It is therefore an object of the present invention to provide a cost effective means for providing home ownership to persons of any financial means.

It is another object of the present invention to simplify the method of financing the purchase of real estate.

It is another object of the present invention to simplify the method of purchasing real estate.

### DETAILED DESCRIPTION OF THE PREFERRED EMBODIMENTS

The present invention provides an improved method for conducting real estate sales transactions. Those skilled in the art will appreciate that real estate sales transactions are very complex and complicated. Their complexity is surpassed perhaps only by the complexity of the sale of a business. The present invention substantially eliminates these complexities and the accompanying additional costs. This allows persons in practically any financial situation to achieve home ownership.

The present invention comprises a method for a business entity to provide home ownership for persons to which it was previously unavailable. This is accomplished by providing an entirely new method of real estate transfer.

A real estate financing entity (REFE) controls the transfer of a parcel of real estate from the original owner through a buyer. The REFE acts as a “straw man” that facilitates a lease-to-own type of transaction. As used herein, the term “entity” refers to an individual, a partnership, a company, a corporation, or other legally recognized legal entity, such as an L.L.C. or P.L.C. The entity must be financially sound, such that classic financial institutions, such as banks, are willing to extend secured and/or unsecured credit to the entity. This financial stability may be accomplished by any of the numerous known means in the art. The REFE then purchases real estate from a typical seller. The seller may include an individual, an individual using a real estate agency, a real estate agency, a land developer, a bank, government, a home builder and the like. Purchase monies may be obtained from credit lines from financial institutions or from the entity's operating capital. Once the REFE has acquired title to the real estate, it may then form a sales contract with a buyer. Neither the REFE nor the buyer use real estate or any other type of agents. A price is agreed upon, risks calculated and a payment schedule is made. Payments are typically a certain amount paid on a monthly basis. However, they may also be paid annually, bi-monthly, semi-annually or any other schedule agreed to by the REFE and the buyer. The REFE maintains title to the property until the final payment is made. Once the final payment is made, the REFE transfers title to the buyer. By maintaining title, the REFE minimizes the risk involved in being the buyer's lender. This eliminates the need for the REFE to verify income, credit history and other information about the buyer.

The REFE may conduct this method one piece of real estate at a time or alternatively, may be constantly acquiring and selling several pieces of real estate simultaneously. The present invention is especially advantageous when used in conjunction with real estate developers. The last few lots and/or homes in a real estate development may be bought in bulk at a reduced price. This further reduces the price that may be charged to the buyer by the REFE.

Because the sale from the REFE to the buyer requires practically no overhead costs, the property may be sold at the REFE's cost to the buyer with a slightly higher interest rate. Typically, the REFE charges the buyer an interest rate of approximately four (4) percentage points above the current indexed rate according to the Wall Street prime and exceeds three (3) percentage points above the interest rates that the REFE pays to borrow the money for the original purchase of the property. This allows the REFE to make a modest profit while providing the buyer a reasonable price and an opportunity to own real estate that the buyer would not otherwise have.

### EXAMPLE 1

Purchase 4 homes at $90,000 each for a total of $360,000 (each home has an appraised value of $100,000 for a total of $400,000)

Borrow $80,000 on each home (89% LTP or 80% LTV); get loans for 15 yrs fixed Sell homes for $100,000 each; carry $95,000 for 30 yrs on an ARM Contract For Deed

| Initial Cash Out of Pocket | | |
|---|---|---|
| Deposit | $1,000 × 4 | $04,000 |
| Down Payment | $9,000 × 4 | $36,000 |
| Home Insurance | $175 × 4 | $00,700 |
| Appraisals | $250 × 4 | $01,000 |
| Lender Processing/Orig Fee | $580 × 4 | $02,320 |
| Lender Origination Fee | $400 × 4 | $01,600 |
| Title Company (closing) | $200 × 4 | $00,800 |
| Title Company (title opinions) | $225 × 4 | $00,900 |
| Title Company (final search) | $100 × 4 | $00,400 |
| Title Company (title insurance) | $200 × 4 | $00,800 |
| County Clerk (filing fees) | $075 × 4 | $00,300 |
| County Clerk (mortgage tax) | $075 × 4 | $00,300 |
| Prepaid Interest Costs | $370 × 4 | $01,480 |
| Ads | $250 × 4 | $01,000 |
| Sales Commission | $500 × 4 | $01,000 |
| Sale Closing Costs | $100 × 4 | $00,400 |
| Total | | $53,000 |
| Initial Cash Back In | | |
| Down Payment | $5,000 × 4 | $20,000 |
| Closing Costs | $750 × 4 | $03,000 |
| Total | | $23,000 |
| $53,000 − $23,000 = | $30,000 | (total initial out |
| | | of pocket expenses) |
| Equity at Start | | |
| The Consumers Owe Us | $95,000 × 4 | $380,000 |
| We Owe Our Bank | $80,000 × 4 | $320,000 |
| Total | $15,000 × 4 | $060,000 |
| Equity at 1 Year | | |
| The Consumers Owe Us | $94,414 × 4 | $377,656 |
| We Owe Our Bank | $76,467 × 4 | $305,868 |
| Total | $17,947 × 4 | $071,788 |
| Equity at 2 Years | | |
| The Consumers Owe Us | $93,770 × 4 | $375,080 |
| We Owe Our Bank | $72,736 × 4 | $290,944 |
| Total | $21,034 × 4 | $084,136 |
| Payments In To Us | | |
| The Consumers Pay Us | $781.61 × 4 | $3,126.44 |
| | | per month |
| Borrowing $380,000 × 9.25% For 30 Years | | |
| Payments We Will Make To The Bank | | |
| We Pay | $707.93 × 4 | $2,831.71 |
| | | per month |
| Borrowing $320,000 × 6.75 % For 15 Years | | |
| Positive Cash Flow Analysis - Monthly & Annual | | |
| $3,126.44 − $2,831.71 = | $294.73 | (monthly |
| | | positive cash flow) |
| $294.73 × 12 = | $3,536 | (annual |
| | | positive cash flow) |

### EXAMPLE 2

### REFE Business Model ROI Projections

For Example:

| Purchase four (4) properties at one time | | | |
|---|---|---|---|
| REFE Purchase Price | $90,000 | 4 | $360,000 |
| REFE Resell/Owner Finance Price | $100,000 | 4 | $400,000 |
| REFE typical financing of purchases would include: | | | |
| Initial Cash out of Pocket (see example 1 above) | | | $ 53,000 |
| Finance each property | 0.88889 | | $320,000 |
| Payment 15 yrs 6.75% | | | ($ 2,832) |
| REFE Owner Financing Package to Customer would include: | | | |
| Receiving Down Payment of $5,000 from each customer | $5,000 | | $20,000 |
| Receiving Closing costs of $750 from each customer | $750 | | $3,000 |
| Assume 2 months to sale, and close all four properties | | | |
| Total (see example 1 above) | | | $23,000 |
| | Customer | Purchase | Amount |
| | Payment | Price | Financed |
| Owner Finance each home at $95,000 | | | |
| Customer payments to REFE 30 yrs 9.25% | | | |
| | $3,126 | $400,000 | $380,000 |
| Total Incoming Payments | $3,126 | $400,000 | $380,000 |

| Month | | | | | | | | | | | |
|---|---|---|---|---|---|---|---|---|---|---|---|
| 1 | 2 | 3 | 4 | 5 | 6 | 7 | 8 | 9 | 10 | 11 | 12 |

Total Mortgage Receivables: $380,000 @ 9.25%

| | | | | | | | | | | |
|---|---|---|---|---|---|---|---|---|---|---|
| For 30 | $3,126 | $3,126 | $3,126 | $3,126 | $3,126 | $3,126 | $3,126 | $3,126 | $3,126 | $3,126 |
| yrs = | | | | | | | | | | |

Cash Proceeds from Initial Down Payments: $23,000
Total Incoming Cash:

| | | | | | | | | | | | | |
|---|---|---|---|---|---|---|---|---|---|---|---|---|
| $23,000 | $3,126 | $3,126 | $3,126 | $3,126 | $3,126 | $3,126 | $3,126 | $3,126 | $3,126 | $3,126 | $3,126 | $57,388 |

Cash Outlay:
Initial Cash Investment ($53,000)

| | |
|---|---|
| Mortgage | ($2,832) ($2,832) ($2,832) ($2,832) ($2,832) ($2,832) ($2,832) ($2,832) ($2,832) ($2,832) ($2,832) ($31,149) |
| Payments | |

REFE Financing:
$320,000 @ 6.75% For 15 yrs = ($2,832)

| | | | | | | | | | | | | |
|---|---|---|---|---|---|---|---|---|---|---|---|---|
| Posi- | $294 | $294 | $294 | $294 | $294 | $294 | $294 | $294 | $294 | $294 | $294 | $26,239 |
| tive | | | | | | | | | | | | |
| Cash | | | | | | | | | | | | |
| Flow: | | | | | | | | | | | | |

| | |
|---|---|
| REFE | ($30,000) ($29,706) ($29,411) ($29,117) ($28,822) ($28,528) ($28,233) ($27,939) ($27,644) ($27,350) ($27,055) ($26,751) |
| Payback | |
| Balance | |

Property Equity Gain:

| | | | | | | | | | | | | |
|---|---|---|---|---|---|---|---|---|---|---|---|---|
| REFE | $1,032 | $1,038 | $1,043 | $1,049 | $1,055 | $1,061 | $1,067 | $1,073 | $1,079 | $1,085 | $1,091 | $11,673 |
| Equity | | | | | | | | | | | | |
| Gain | | | | | | | | | | | | |
| Buyer | ($197) | ($199) | ($200) | ($202) | ($203) | ($205) | ($206) | ($208) | ($209) | ($211) | ($213) | ($2,252) |
| Equity | | | | | | | | | | | | |
| Gain | | | | | | | | | | | | |
| REFE | $835 | $839 | $843 | $848 | $852 | $856 | $861 | $865 | $870 | $874 | $879 | $9,421 |
| Net | | | | | | | | | | | | |
| Equity | | | | | | | | | | | | |
| Gain | | | | | | | | | | | | |
| Cumula- | | $835 | $1,674 | $2,517 | $3,365 | $4,217 | $5,073 | $5,934 | $6,799 | $7,668 | $8,542 | $9,421 |
| tive | | | | | | | | | | | | |
| Gain | | | | | | | | | | | | |

Customer Cash Out:
Cash Proceeds to REFE

$30,000 $31,129 $32,262 $33,400 $34,542 $35,688 $36,839 $37,994 $39,154 $40,318 $41,487 $42,660

REFE Total Profit

$30,000 $31,129 $32,262 $33,400 $34,542 $35,688 $36,839 $37,994 $39,154 $40,318 $41,487 $42,660

Return on Investment

| | | | | | | | | | | | |
|---|---|---|---|---|---|---|---|---|---|---|---|
| 56.60% | 58.73% | 60.87% | 63.02% | 65.17% | 67.34% | 69.51% | 71.69% | 73.88% | 76.07% | 78.28% | 80.49% |

| | | Year 1 | Year 2 | Year 3 | Year 4 | Year 5 | Total |
|---|---|---|---|---|---|---|---|
| Mortgage Receivables | | | | | | | |
| Total Incoming Cash | | $34,388 | $37,514 | $37,514 | $37,514 | $37,514 | $184,444 |
| $380,000 @ 9.25% for 30 yrs | | | | | | | |
| $3,126 per month | | | | | | | |
| Mortgage Payables | | | | | | | |
| Total Outgoing Cash | | ($31,152) | ($33,984) | ($33,984) | ($33,984) | ($33,984) | ($167,088) |
| $320,000 @ 6.75% for 15 yrs | | | | | | | |
| ($2,832) per month | | | | | | | |
| Initial Cash Outlay | ($53,000) | | | | | | |
| Initial Return - | $23,000 | | | | | | |
| Down Payments | | | | | | | |
| Initial Out Of Pocket | ($30,000) | | | | | | |
| Initial Equity | $60,000 | | | | | | |
| Initial Profit | $30,000 | | | | | | |

| | | | | | | |
|---|---|---|---|---|---|---|
| Positive Cash Flow | $3,239 | $3,530 | $3,530 | $3,530 | $3,530 | $17,359 |
| Property Equity Gain: | | | | | | |
| REFE Equity Gain | $11,673 | $14,757 | $14,611 | $15,629 | $16,717 | $73,387 |
| Buyer Finance Equity Gain | $2,252 | $2,683 | $2,966 | $3,252 | $3,565 | $14,718 |
| REFE Net Equity Gain | $9,421 | $12,074 | $11,645 | $12,377 | $13,152 | $58,669 |
| REFE Cumulative Equity Gain | $9,421 | $21,495 | $33,140 | $45,517 | $58,669 | |
| When Buyer Pays REFE Off: | | | | | | |
| Cash Proceeds to REFE | $42,660 | $58,264 | $73,439 | $89,346 | $106,028 | |
| REFE Total Profit | $42,660 | $58,264 | $73,439 | $89,346 | $106,028 | |
| Return on Investment | 80.49% | 109.93% | 138.57% | 168.58% | 200.05% | |

1. A method of transferring real estate comprising:
purchasing at least one parcel of real estate by means of traditional methods; transferring the at least one parcel of real estate to at least one buyer, such that the real estate is transferred in exchange for a monetary amount and is transferred in increments on a regular basis according to a schedule, such that transfer of the real estate title takes place subsequent to the final payment according to the schedule, and financing is provided to the buyer utilizing a financing method selected from the group consisting of owner carry, owner financed and owner financing and that does not require the buyer to qualify for a loan.

2. A method of claim 1 wherein at least one parcel of real estate comprises a plurality of parcels of real estate.

3. A method of claim 2 wherein the plurality of parcels of real estate comprise real estate lots and/or homes from a real estate development.

4. A method of claim 1 wherein at least one buyer comprises a plurality of buyers.

5. The method of claim 1 wherein the sale to the buyer is a sale not requiring a background check, an employment check, review of tax returns, review of bank statements or a credit check on the buyer.

6. A method of claim 1 wherein a builder builds homes with the intent to sell said homes in a manner similar to that of claim 1.

7. A method of claim 1 wherein a potential buyer that is unable to obtain financing, locates a home not already owned by the REFE. The home is then purchased by the REFE for the benefit of the buyer, and sold to the buyer in the manner as set forth in claim 1.
